(19) United States
(12) Patent Application Publication
(10) Pub. No.: US 2024/0242434 A1
(43) Pub. Date: Jul. 18, 2024

(54) METHOD FOR GENERATING A SURFACE OFFSET OF A VOXEL-BASED 3D MODEL OF A PHYSICAL OBJECT

(71) Applicant: Hyperforge Holdings Pte Ltd., Singapore (SG)

(72) Inventor: Michael GALLO, Valeggio sul Mincio (IT)

(21) Appl. No.: 18/606,539

(22) Filed: Mar. 15, 2024

Related U.S. Application Data
(63) Continuation of application No. PCT/EP2022/075850, filed on Sep. 16, 2022.

(30) Foreign Application Priority Data
Sep. 16, 2021 (DE) 10 2021 124 013.1

(51) Int. Cl. G06T 17/00

(52) U.S. Cl. CPC G06T 17/005

(57) ABSTRACT

A method is provided for creating a second voxel model (VM2) from a first voxel model (VM) to generate a surface offset for an object represented by the first voxel model.

### CROSS REFERENCE TO RELATED APPLICATIONS

This application is a continuation under 35 U.S.C. § 120 of International Application PCT/EP2022/075850, filed Sep. 16, 2022, which claims priority to German Application No. 10 2021 124 013.1, filed Sep. 16, 2021, the contents of each of which are incorporated by reference herein.

### FIELD OF THE INVENTION

The invention relates to a method for processing a voxel-based 3D model of a physical object for generating a surface offset of the voxel-based 3D model.

### BACKGROUND OF THE INVENTION

In the field of 3D printing, it is known to represent physical objects by 3D models, wherein the shape of an object can be represented by means of a voxel model or a voxel field.

A voxel model comprises a plurality of voxels, i.e., three-dimensional spatial units. In order to image the shape of an object by means of a voxel model, the distance of individual voxels of the voxel model to the surface of the object is determined. It is expedient in this case to store only the distance values of those voxels which are located in the immediate vicinity of the surface of the object. The compression rate and the speed of some algorithms can thereby be improved, since considerable spatial sections can be skipped at a sufficient distance to the surface of the object.

However, sparsely populated voxel models are disadvantageous for certain types of 3D model processing, in particular offsetting (=creating a surface offset of the voxel-based 3D model). For example, during offsetting, distance values of voxels are also to be processed which are located somewhat further away from the surface of the object. However, the distance values are absent in a memory-optimized, sparsely populated voxel model for the voxels affected by the offset.

### OBJECT OF THE INVENTION

The object of the present invention is therefore to provide a method for efficient reconstruction of missing information in a storage-optimized voxel model, wherein the voxel model represents a 3D model of a physical object for controlling a 3D printer.

### Solution According to the Invention

The object is achieved by a method having the features according to independent claim 1. Advantageous developments of the invention are defined in the dependent claims.

According to the invention, a computer-implemented method for creating a second voxel model from a first voxel model is provided. The first voxel model which has first voxels represents a 3D model of a physical object. A distance attribute is assigned to each first voxel, whereby the distance of the respective first voxel to the surface of the object can be stored in the distance attribute. For each first voxel whose minimum distance in terms of magnitude is below a first predetermined threshold value, the minimum distance in terms of magnitude is stored in the distance attribute. A predetermined distance is stored in the distance attribute for each first voxel whose minimum distance in terms of magnitude is above the first predetermined threshold value.

The first voxel model therefore has a sparsely populated data structure.

In a first step, the second voxel model is generated. The second voxel model has second voxels and a dimension identical to the first voxel model. Each first voxel corresponds to a second voxel. A distance attribute is assigned to each second voxel, wherein the distance of the respective second voxel to the surface of the object can be stored in the distance attribute.

In a second step, the first voxel model iterates in a first direction. For each first voxel with a stored predetermined distance, a first approximated distance is determined for the corresponding second voxel and stored in the distance attribute of the corresponding second voxel.

In a third step, the first voxel model iterates in a second direction. For each first voxel with a stored predetermined distance, a second approximated distance is determined for the corresponding second voxel with inclusion of the first approximated distance. The second approximated distance is stored in the distance attribute of the corresponding second voxel.

The second voxel model represents a 3D model of the physical object for controlling a 3D printer. Control instructions for controlling the 3D printer are derived from the second voxels. The control instructions are provided for transmission to the 3D printer.

By means of the method according to the invention, an approximated distance to the surface of the physical object can therefore be calculated for each voxel in which the distance information is absent.

The second voxel model is retained in the memory independently of the first voxel model, i.e., in any case, two voxel models exist in the memory during the execution of the method. This also has the advantage that the original voxel model (=the first voxel model) remains unchanged.

The method according to the invention has the advantage that the speed for calculating the approximated distances scales linearly with the size of the voxel model. This means that the method according to the invention has a runtime complexity of O(n) which is advantageous in particular with voxels models having a very large number of voxels. The method according to the invention can therefore also be used in voxels models representing large physical objects. By calculating the approximated distances, an offsetting of the shape of the physical object which is represented by a voxel model is enabled. The approximated distances generated using the method according to the invention have sufficiently good accuracy.

In the second step, the stored distance is advantageously additionally copied into the respective distance attribute of the second voxel for each first voxel with a stored distance in the distance attribute.

According to the invention, it is therefore provided that the exact distances of the sparsely populated first voxel model are transferred to the second voxel model. This ensures that the distances of the voxels near the surface of the object are as precise as possible.

Alternatively in the first step, the second voxel model can be initialized as a copy of the first voxel model.

Preferably, in the third step, first voxels which have a stored distance in the distance attribute are skipped.

In an advantageous embodiment, in the second step and/or in the third step, the first approximated distance and/or the second approximated distance for the respective second voxels is determined from the stored distances of those second voxels which are adjacent to the respective second voxel up to a predetermined number of voxels, preferably in each direction.

This embodiment has the technical advantage that the accuracy is adjustable in the determination of the approximated distances. The more neighboring second voxels are included in the calculation of the approximated distance of a voxel, the more accurately the distance of the voxel to the surface of the object can be approximated. However, the number of adjacent second voxels also increases the execution time of the method. Depending on the offset depth to be achieved, a compromise can therefore be found between the execution time and the accuracy of the offsetting using the advantageous embodiment of the method according to the invention. However, the method according to the invention has a runtime complexity of O(n) regardless of the number of included neighboring voxels.

The predetermined number of voxels is preferably 2. This means that two adjacent voxels are included in the calculation of the approximated distance in each direction.

According to the inventor's findings, limiting the search for approximated distances of a voxel to the second voxel neighboring the voxel within a radius of two voxels provides sufficient accuracy of the approximated distances for practice.

Also preferably, the predetermined distance in the distance attribute of a first voxel comprises a first predetermined distance and a second predetermined distance. For a first voxel with a first predetermined distance, the first approximated distance is determined from the maximum of the distances determined from the adjacent second voxels. For a first voxel with a second predetermined distance, the second approximated distance is determined from the minimum of the distances determined from the adjacent second voxels.

A first predetermined distance and a second predetermined distance can be used to differentiate between areas that are enclosed by the surface of the physical object and areas outside the physical object. This distinction has the advantage that the approximated distances can be determined not only in terms of amount, but also in terms of the sign.

Advantageously, the first and/or second approximated distance is only determined from those neighboring second voxels via which iteration already occurred in the respective direction.

In an advantageous embodiment, the first voxel model and the second voxel model are each three-dimensional. In the first direction, starting from an origin, iteration first occurs in a first dimension, then in a second dimension and last in a third dimension.

This method of iterating over a three-dimensional voxel model has the advantage that each voxel of the voxel model is only visited once. Nevertheless, it remains guaranteed that a considerable proportion of the neighboring voxels have already been visited beforehand to determine the approximated distance of a voxel. Thus, for each voxel, apart from the voxels at the edge of the voxel model, a similar number of adjacent voxels contribute to the determination of the approximated distance to the surface of the object. In this way, systematic deviations in the calculation of approximated distances of voxels to the surface of the object can be reduced.

It is also advantageous if, in the second direction, starting from the first voxel furthest away from the origin, iteration first occurs over the first dimension, then over the second dimension and finally over the third dimension in descending order.

In an advantageous embodiment, the distance and/or the second approximated distance are stored for each second voxel only when it additionally meets a predetermined storage criterion.

Thus, the second voxel model can finally be limited to the distance values relevant to the control of the 3D printer in the vicinity of the surface of the object after processing.

In the generated second voxel model, any voxels can therefore be added to or removed from the surface of the physical object using the approximated distances. An offset of the object represented by the second voxel model can therefore be generated, which is why this form of processing a 3D model is also referred to as “offsetting.”

In particular in 3D printing, offsetting is used to print a physical object with an additional envelope, wherein the envelope is eliminated or removed in a post-processing step, i.e., after the 3D printing. This has the advantage that, for example, the resolution limits of the 3D printer can be overridden, and a precise realization of the shape of the printed physical object can be guaranteed. Finally, the subsequent removal of print material is advantageous in terms of processing compared to the subsequent addition of print material.

Preferably, the first voxels and/or the second voxels are each stored in a tree structure. The tree structure comprises a root node and a predetermined maximum first number of hierarchy levels. A predetermined second number of sub-nodes can be assigned to each node of a hierarchy level.

It is particularly advantageous if the predetermined maximum number of hierarchy levels is 3, and the predetermined second number of sub-nodes 4096 is such that each node of a hierarchy level, with the exception of the lowest hierarchy level, can be assigned 4096 sub-nodes.

Preferably, the second voxel model generated in the first step has the same number of second voxels as the first voxel model has first voxels.

In an advantageous embodiment, the offsetting from the generated second voxel model can be implemented by adjusting a distance value, which is stored in the distance attribute of the respective second voxel, by a predetermined offset distance and storing it in the distance attribute. For each second voxel whose adjusted distance value is above the first predetermined threshold value, the adjusted distance value is replaced by the predetermined distance.

The distance value that is stored in the distance attribute of the respective second voxel can be the minimum distance in terms of magnitude, or the second approximated distance.

The predetermined offset distance can be both positive and negative. A positive offset distance adds voxels to the surface of the physical object, which usually also increases the volume of the physical object. A negative offset distance removes voxels from the surface of the physical object.

In a further advantageous embodiment, the offsetting can be generated from the generated second voxel model in that a distance value, which is stored in the distance attribute of the respective second voxel and is not a predetermined distance, is adjusted by the predetermined offset distance and is stored in the distance attribute. For each second voxel whose adjusted distance value is above the first predetermined threshold value, the adjusted distance value is replaced by the predetermined distance.

This embodiment has the advantage that the adjustment of the distance values by the offset distance only has to be carried out for those second voxels whose minimum distance in terms of magnitude is below the second predetermined threshold value. This considerably reduces the number of voxels for which the adjustment has to be made.

By offsetting, the surface implicitly defined in the first voxel model can be transformed into a second implicitly defined surface, which is then stored in the second voxel model. Due to the distance values in the individual voxels, the surface in the first voxel model and the surface in the second voxel model are implicitly defined.

### BRIEF DESCRIPTION OF THE FIGURES

Further details and features of the method according to the invention as well as specific, in particular advantageous embodiments of the method according to the invention are evident from the following description in conjunction with the drawing. In the figures:

FIG. 1 shows a plane of a first voxel model according to one embodiment of the method according to the invention;

FIG. 2 shows a plane of a second voxel model corresponding to the plane of the first voxel model of FIG. 1 after the second step of an embodiment of the method according to the invention;

FIG. 3 shows the second plane from FIG. 2 after the third step of an embodiment of the method according to the invention;

FIG. 4a shows a determination of the first approximated distance for a second voxel according to one aspect of the invention;

FIG. 4b shows a determination of the second approximated distance for the second voxel of FIG. 4a according to one aspect of the invention;

FIG. 5 shows a plane of the second voxel model corresponding to the plane of the first voxel model of FIG. 1 after offsetting according to one aspect of the invention;

FIG. 6a shows an exemplary embodiment of the plane from FIG. 3 with specific distance values; and

FIG. 6b shows the plane of FIG. 6a after adjusting the distance values by an offset distance.

### DETAILED DESCRIPTION OF THE INVENTION

In the present invention, the term “offsetting” in the context of processing 3D models describes any processing of a 3D model according to which the shape of the object to be printed is changed to the outside and/or to the inside at least sectionally.

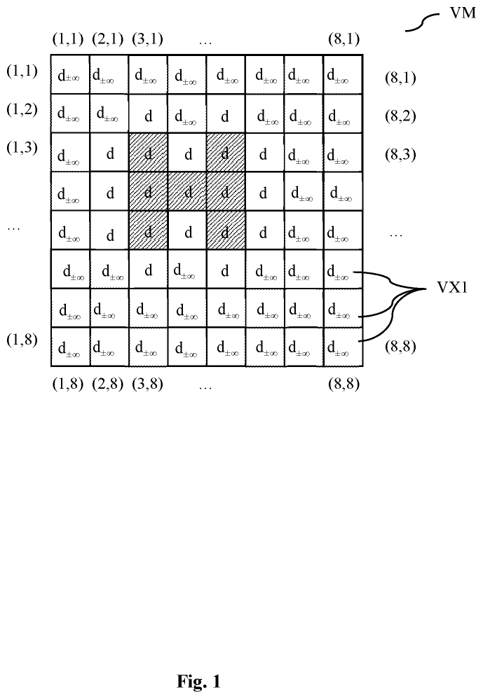

FIG. 1 shows a plane of a first voxel model according to one embodiment of the method according to the invention.

The plane shown in FIG. 1 is taken from a three-dimensional first voxel model VM (not shown) and serves in the following as an example for explaining the method according to the invention.

The typically three-dimensional first voxel model VM has a first dimension X, a second dimension Y, and a third dimension Z (not shown). For the sake of clarity, the plane of the first voxel model VM shown in FIG. 1 has eight voxels in the first dimension X and in the second dimension Y in each case. In a real voxel model, a considerably higher voxel density usually exists, for example in order to achieve as high a resolution as possible when realizing the richness of detail of a physical object. In the following example, specific first voxels VX1 of the first voxel model VM are referenced by means of coordinate pairs X, Y.

In the plane of the first voxel model VM shown in FIG. 1, the physical object represents an “H.” The surface of the physical object is formed by those first voxels VX1 which are shown as obliquely hatched.

A distance attribute d or d_{±∞} is assigned to each first voxel VX1, whereby the distance of the respective first voxel VX1 to the surface of the object can be stored in the distance attribute.

For each first voxel VX1 whose minimum distance d in terms of amount is below a first predetermined threshold value d_{MAX}, the minimum distance in terms of magnitude is stored in the distance attribute. In the example of FIG. 1, d_{MAX} is equal to the size of a first voxel VX1. The predetermined threshold values d_{MAX} can however also be selected to be greater. The minimum distance d in terms of magnitude of those first voxels VX1 that form the surface of the object is zero, for example, and is therefore stored in the distance attribute of these first voxels VX1. Similarly, the minimum distance d in terms of magnitude of those first voxels VX1 is stored in the distance attribute whose distance to the surface of the object is at most one first voxel VX1.

A predetermined distance d_{±∞} is stored in the distance attribute for each first voxel VX1 whose minimum distance in terms of magnitude is above the first predetermined threshold value d_{MAX}. The predetermined distance d_{±∞} therefore marks spatial areas that are not occupied by the physical object and can therefore be skipped when processing the 3D model. However, when offsetting the surface of the physical object, more than just the nearest voxels to the surface of the physical object are affected.

According to the invention, a second voxel model VM2, which has second voxels VX2, is therefore generated in a first step S1 with a dimension identical to the first voxel model VM. A first voxel VX1 corresponds to a second voxel VX2. A distance attribute is also assigned to each second voxel VX2, wherein the distance d of the corresponding second voxel VX2 to the surface of the object can be stored in the distance attribute.

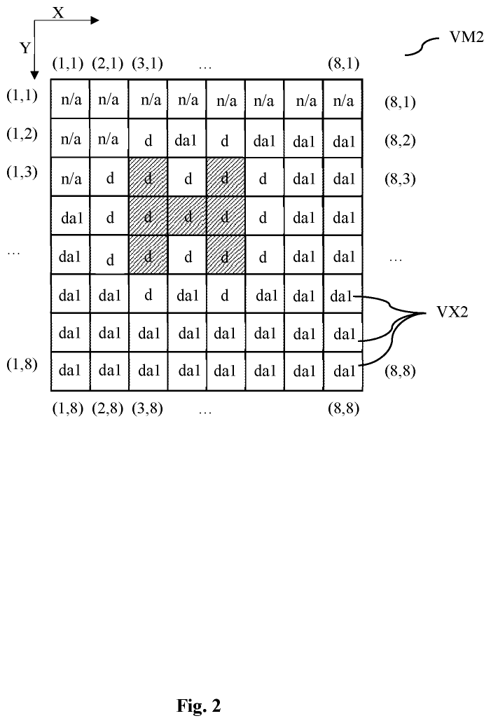

FIG. 2 shows a plane of a second voxel model corresponding to the plane of the first voxel model of FIG. 1 after execution of the second step of an embodiment of the method according to the invention.

In a second step S2, the first voxel model VM iterates in a first direction. The reconstruction of the second voxel model VM2 in the second step S2 (and later also in the third step S3) takes place synchronously with the iteration via the first voxel model VM. In the first direction, starting from an origin, iteration first occurs over a first dimension X, then over a second dimension Y and last over a third dimension Z. In the present exemplary embodiment, the origin is characterized by the pair of coordinates (1,1). Thus, first of all in the first dimension X is iterated up, then ascending in the second dimension Y. Synchronously with this, iteration occurs over the second voxels VX2, wherein the second voxels VX2 each correspond to a first voxel VX1.

It is advantageous if the second voxel model VM2 has the same number of second voxels VX2 as the first voxel model VM has first voxels VX1.

In the second step S2, for each first voxel VX1, a first approximated distance d1 is determined at a stored predetermined distance d_{±∞} and stored in the distance attribute of the corresponding second voxel VX2.

In the exemplary embodiment shown here, in the second step S2, the stored distance d is additionally copied into the respective distance attribute of the second voxel VX2 for each first voxel VX1 with a stored distance d in the distance attribute.

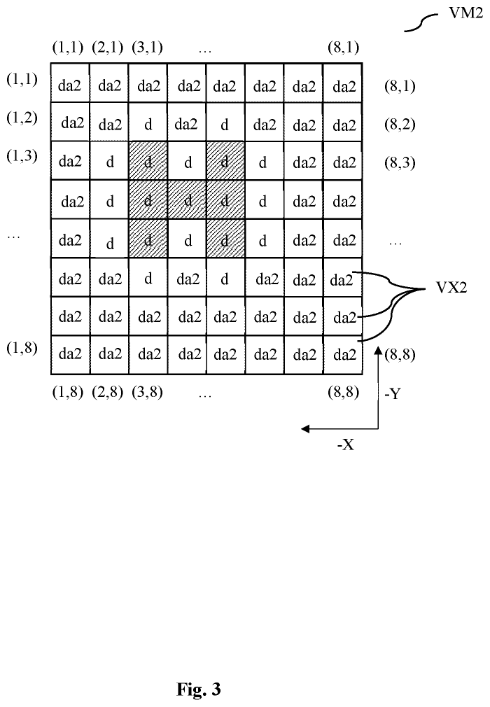

In one aspect of the invention which is also taken into account in the shown exemplary embodiment, the first approximated distance d1 and/or the second approximated distance d2 (see FIG. 3) are determined only from those adjacent second voxels VX2 over which iteration has already been performed in the respective direction. Specifically, this means that no first approximated distance d1 can be determined for a series of second voxels VX2 at the beginning of the iteration in the first direction. For the affected second voxels VX2, after completion of the second step S2 of the method according to the invention, no distance value is available in the distance attribute, which is why the affected second voxels VX2 are labeled “n/a.”

Depending on the first voxel VX1, a different number of neighboring second voxels VX2 contribute to the determination of the approximated distances da1, da2. For example, in the shown exemplary embodiment, the first approximated distance d1 of the voxel (4,2) was only determined on the basis of the distance d previously copied into the distance attribute of the second voxel (3,2). For subsequent first voxels VX1, the first approximated distance d1 can be included from the first approximated distances da1 and/or the minimum distances d in terms of magnitude of already processed adjacent second voxels VX2.

It is advantageous if not all available adjacent second voxels VX2 are included in each case for determining the first approximated distance d1, but only those second voxels VX2 which are adjacent to the respective second voxel VX2 up to a predetermined number of voxels, preferably in each direction. A predetermined number of voxels of two allows sufficiently high accuracy for practical applications of offsetting.

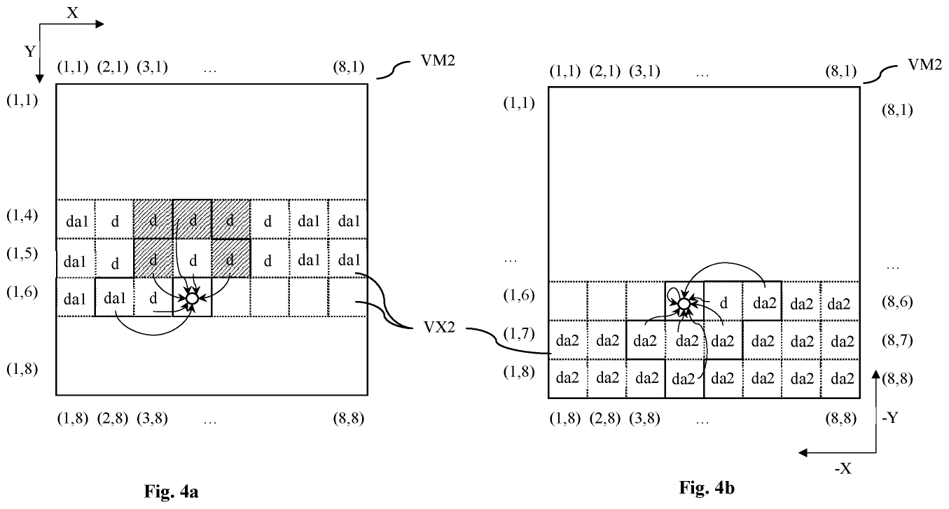

The smaller the selected predetermined number of voxels, the less adjacent second voxels VX2 are included to determine a first approximated distance d1 for a specific second voxel VX2, and the shorter the execution time of the method. A specific example for ascertaining the first approximated distance d1 and the second approximated distance d2 is explained in more detail with reference to FIG. 4.

FIG. 3 shows the second plane from FIG. 2 after executing the third step of an embodiment of the method according to the invention.

In the third step S3, the first voxel model VM is iterated in a second direction. For each first voxel VX1 with a stored predetermined distance d_{±∞}, a second approximated distance d2 is determined for the corresponding second voxel VX2 with inclusion of the first approximated distance d1. Consequently, a corresponding iteration is provided by the second voxel model VM2 synchronously to the iteration by the first voxel model VM.

The determined second approximated distances d2 are stored in the distance attribute of the corresponding second voxels VX2.

In the second direction, starting from the first voxel VX1 furthest away from the origin, iteration preferably first occurs over the first dimension X, subsequently over the second dimension Y, and last over the third dimension Z.

In the present example, the voxels VX1, VX2 furthest from the origin have the coordinates (8,8). According to the invention, iteration is first performed in descending order in the first dimension X, and then in descending order in the Y direction. For a three-dimensional voxel model VM, VM2, iteration finally also occurs over the third dimension Z.

After execution of the third step of the method according to the invention, either the minimum distance d in terms of magnitude or the second approximated distance d2 in terms of magnitude is stored in the distance attribute of each second voxel VX2. This means that a value for the respective distance to the surface of the physical object is available for every second voxel VX2 so that offsetting of the surface of the object can be applied.

After the precise minimum distances d in terms of magnitude have already been copied into the second voxel model VM2 in the second step S2 of the method according to the invention, it is useful to skip those first voxels VX1 which have a stored distance d in the distance attribute in the third step S3.

A specific example for ascertaining the second approximated distance for a second voxel VX2 in the third step S3 of the method according to the invention is explained with reference to FIG. 4.)

FIG. 4a and FIG. 4b show the determination of the approximated distances da1, d2 for a second voxel according to one aspect of the invention.

FIG. 4a shows the determination of the first approximated distance da1, and FIG. 4b the determination of the second approximated distance d2 for the second voxel.

FIG. 4a shows a detail of the second voxel model VM2 during the second step S2 of the method according to the invention during the determination of the first approximated distance d1 of the first voxel VX1 with the pair of coordinates (4,6).

The second voxels VX2 shown in FIG. 4 are shown by dashed and dotted squares. Those second voxels VX2 which are adjacent to the second voxel (4,6) and contribute to determining the first approximated distance d1 are marked with a solid line in FIG. 4a.

In the shown exemplary embodiment, the predetermined number of voxels is selected to be equal to two. In each direction, only those second voxels VX2 therefore contribute to the distance determination which are at most two voxels from the selected second voxel VX2, here (4,6). As shown in FIG. 4a, the first approximated distance d1 of the second voxel (4,6) is accordingly determined from the distance values of six adjacent second voxels VX2, as indicated by arrows.

The first voxel VX1 corresponding to the second voxel (4,6) has a predetermined distance d_{±∞} in the stored distance attribute. It is advantageous if, however, a distinction is made between a first predetermined distance d_{+∞} and a second predetermined distance d_{-∞}. Thus, the first predetermined distance d_{+∞} can characterize a first voxel VX1 which is located outside the physical object. Correspondingly, the second predetermined distance d_{-∞} can characterize a first voxel VX1 which located within the physical object.

In one aspect of the invention, for a first voxel VX1 with a first predetermined distance d_{+∞}, the first approximated distance da1 can be determined from the minimum of the distances determined from the adjacent second voxels VX2. If a first voxel VX1 has a second predetermined distance d_{-∞} the first approximated distance d1 can be determined from the maximum of the distances determined from the adjacent second voxels VX2. Alternatively, the first approximated distance d1 can also be calculated by averaging the distances determined for the adjacent second voxels VX2.

FIG. 4b shows the determination of the second approximated distance d2 of the same first voxel VX1 (4,6) during the third step S3 of the method according to the invention.

In the third step S3 of the method according to the invention, iteration occurs in the second direction through the first voxel model VM, and synchronously thereto through the second voxel model VM2. The second voxels VX2 of the detail of the exemplary second voxel model VM2 shown in FIG. 4b are again characterized by dotted squares. Those second voxels VX2 which contribute to determining the second approximated distance d2 are at least partially outlined by a solid line.

Due to the deviating, approximately opposite iteration direction compared to the second step S2, other adjacent second voxels VX2 contribute to determining the second approximated distance d2 of the second voxel (4,6) in the third step S3. Furthermore, the first approximated distance d1 determined in the second step S2, which is already stored in the distance attribute of the selected second voxel (4,6), is also included.

The second approximated distance d2 from the adjacent second voxels VX2 can be determined analogously to the calculation of the first approximated distance d1, i.e., by calculating a minimum, a maximum, or an averaging of the distances associated with the adjacent second voxels VX2.

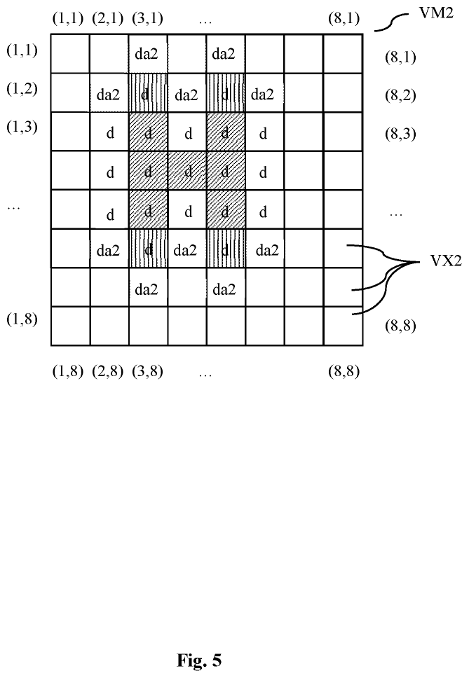

FIG. 5 shows a plane of the second voxel model corresponding to the plane of the first voxel model of FIG. 1 after offsetting according to one aspect of the invention.

After execution of the third step S3, a distance value d, d2 is stored in the distance attribute in every second voxel. Thus, the second voxel model VM2 represents a 3D model of the physical object for controlling a 3D printer, wherein control instructions for controlling the 3D printer can be derived from the second voxels VX2, and the control instructions for transmission to the 3D printer are provided.

Based on the second voxel model VM2, the 3D model of the physical object can be digitally processed prior to 3D printing. The stored distances in distance attributes of the second voxels VX2 can therefore be adapted such that selected second voxels VX2 are added to and/or removed from the surface of the physical object. This realizes an offsetting of the shape or surface of the physical object. In the example according to FIG. 5, the second voxels VX2 marked with vertical hatching have been added to the surface of the physical object.

It is advantageous if, after the processing of the 3D model, the distance d or the second approximated distance d2 is only stored for each second voxel VX2 if an additional storage criterion is met. The storage criterion can in turn be implemented for example as a prespecified threshold value for the distance of the second voxels VX2.

In the example shown in FIG. 5, for the sake of clarity, those second voxels VX2 which do not meet the predetermined storage criterion are shown as empty squares. However, for those second voxels VX2 whose distance value in the distance attribute lies below a second predetermined threshold value d2_{MAX} (=predetermined storage criterion), the distance d, da2 is stored in the distance attribute.

In this way, a second voxel model VM2 can also be persisted in a sparse and therefore storage-optimized data structure after offsetting.

In the following, an example of offsetting concretized by numerical values is explained based on the second voxel model VM2 according to one aspect of the invention.

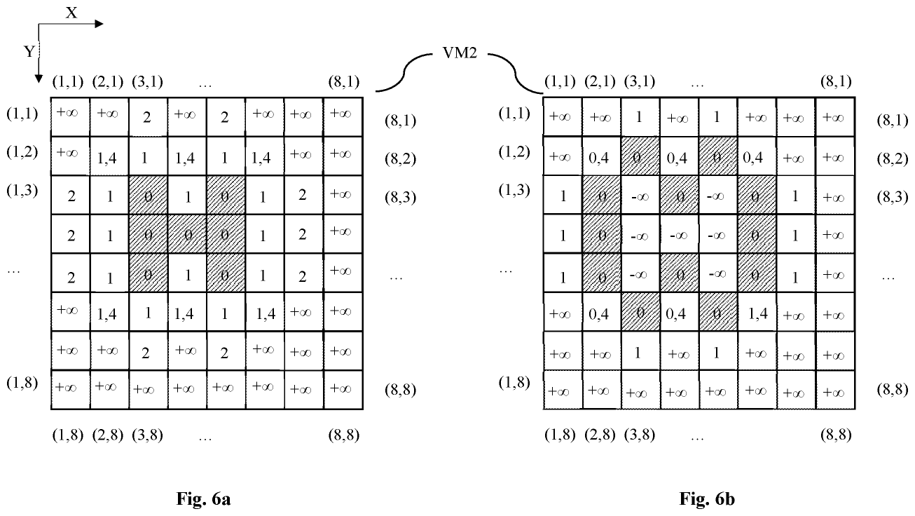

FIG. 6a shows an exemplary embodiment of the plane from FIG. 3 with specific distance values.

For the second voxel model VM2 shown in FIG. 6a, a distance value for the second voxels VX2 was determined in each case by performing the steps of the method according to the invention and stored in the associated distance attribute. All those distance values which lie above the predetermined second threshold value have been replaced by the first predetermined distance d_{+∞}, here “+∞.”

The predetermined second threshold value in this example is “2,1” for the region outside the surface of the physical object and “−0,1” for the region within the physical object. This means that in the second voxel model VM2 of FIG. 6a, distance values are only stored for those second voxels VX2 whose determined distance lies between “−0,1” and “2,1”.

FIG. 6b shows the plane of FIG. 6a after adjusting the distance values by an offset distance.

In this exemplary embodiment, the offset distance is “+1” (for example 1 mm). For offsetting, the distance values stored in the respective second voxel VX2 are adjusted by the offset distance. In this case, the value “1” is subtracted from the stored distance values. In this exemplary embodiment, the second voxels VX2 in which a predetermined distance is stored are not adapted. The adjustment by the offset distance is therefore only carried out for those second VX2 voxels in which no predetermined distance value is stored.

In this example, an adjusted distance value d_{O} of “−1” is therefore determined for those second voxels VX2 that are part of the surface of the physical object, i.e., that have the distance value “0” stored in FIG. 6a. Advantageously, the adjusted distance values are in turn filtered with the predetermined first threshold value.

In this example, the predetermined first threshold value is “1,1” for the region outside the surface of the physical object and “−0,1” for the region within the physical object. The second voxels VX2, which have an adjusted value of “−1”, have therefore been replaced in this example by the predetermined distance d_{-∞}, here “−∞.”

FIG. 6b therefore illustrates how an envelope, in particular a uniform envelope, can be efficiently placed around the physical object by the offsetting. In the same way, with a negative offset distance, a layer of the physical object, in particular a layer having a constant thickness, can be removed. In both cases, a transformation of the surface described in the voxel model is therefore carried out.

### LIST OF REFERENCE SIGNS

VM First voxel model
VM2 Second voxel model
VX1 First voxel
VX2 Second voxel
d Minimum distance in terms of magnitude of a voxel to the surface of the
physical object
d_{±∞} Predetermined distance
d_{+∞} First predetermined distance
d_{-∞} Second predetermined distance
d_{O} Adjusted distance value
d1 First approximated distance
d2 Second approximated distance
d_{MAX} Predetermined threshold
d2_{MAX} Additionally predetermined threshold value
S1 First step of the method according to the invention
S2 Second step of the method according to the invention
S3 Third step of the method according to the invention

1. A computer-implemented method for creating a second voxel model (VM2) from a first voxel model (VM), wherein the first voxel model (VM), which has first voxel (VX1), represents a 3D model of a physical object, wherein a distance attribute is assigned to each first voxel (VX1), wherein the distance of the respective first voxel (VX1) to the surface of the object can be stored in the distance attribute, wherein for each first voxel (VX1) whose minimum distance (d) in terms of magnitude lies below a first predetermined threshold value (d_{MAX}), the minimum distance (d) in terms of magnitude is stored in the distance attribute, and for each first voxel (VX1) whose minimum distance in terms of magnitude (d) lies above the first predetermined threshold value (d_{MAX}), a predetermined distance (d_{±∞}) is stored in the distance attribute,
wherein
in a first step (S1), the second voxel model (VM2) that has second voxels (VX2) is generated with a dimension identical to the first voxel model (VM), wherein a first voxel (VX1) corresponds to a second voxel (VX2), wherein a distance attribute is assigned to each second voxel (VX2), wherein the distance (d2) of the respective second voxel (VX2) to the surface of the object can be stored in the distance attribute,
in a second step (S2), iteration is performed in a first direction by the first voxel model (VM), wherein for each first voxel (VX1) with a stored predetermined distance (d_{±∞}), a first approximated distance (da1) is determined for the corresponding second voxel (VX2) and stored in the distance attribute of the corresponding second voxel (VX2),
in a third step (S3), iteration is performed in a second direction by the first voxel model (VM), wherein for each first voxel (VX1) with a stored predetermined distance (d_{±∞}), a second approximated distance (da2) is determined for the corresponding second voxel (VX2) taking into account the first approximated distance (da1) and stored in the distance attribute of the corresponding second voxel (VX2),
wherein the second voxel model (VM2) represents a 3D model of the physical object for controlling a 3D printer, wherein control instructions for controlling the 3D printer are derived from the second voxels (VX2), and the control instructions for transmission to the 3D printer are provided.

2. The method of claim 1, wherein, in the second step (S2), the stored distance (d) is additionally copied into the corresponding distance attribute of the second voxel (VX2) for each first voxel (VX1) with a stored distance (d) in the distance attribute.

3. The method of claim 2, wherein in the third step (S3), first voxels that have a stored distance (d) in the distance attribute are skipped.

4. The method of claim 1, wherein in the first step (S1), the second voxel model (VM2) is initialized as a copy of the first voxel model (VM).

5. The method of claim 1, wherein in the second step (S2) and/or in the third step (S3), the first approximated distance (da1) and/or the second approximated distance (da2) for the corresponding second voxels (VX2) is determined from the stored distances of those second voxels (VX2) which are adjacent to the respective second voxel (VX2) up to a predetermined number of voxels, preferably in each direction.

6. The method of claim 4, wherein the predetermined number of voxels is two.

7. The method of claim 4, wherein:
the predetermined distance (d_{±∞}) in the distance attribute of a first voxel (VX1) comprises a first predetermined distance (d_{+∞}) and a second predetermined distance (d_{-∞}),
for a first voxel (VX1) with a first predetermined distance (d_{+∞}), the first approximated distance (da1) and the second approximated distance (da2) are determined from the minimum of the distances determined from the adjacent second voxels (VX2), and
for a first voxel (VX1) with a second predetermined distance (d_{-∞}), the first approximated distance (da1) and the second approximated distance (da2) are determined from the maximum of the distances determined from the adjacent second voxels (VX2).

8. The method of claim 7, wherein the first and/or the second approximated distance (d1; da2) are only determined from those adjacent second voxels (VX2) via which iteration already occurred in the respective direction.

9. The method of claim 1, wherein the first and second voxel model (VM; VM2) are in each case three-dimensional, wherein in the first direction, starting from an origin, iteration first occurs iteratively over a first dimension (X), then over a second dimension (Y) and last over a third dimension (Z), in each case in ascending order.

10. The method of claim 9, wherein in the second direction, starting from the first voxel (VX1) furthest away from the origin, iteration occurs first over the first dimension (X), then over the second dimension (Y) and finally over the third dimension (Z) in each case in descending order.

11. The method of claim 1, wherein the distance (d) and/or the second approximated distance (da2) is only stored for each second voxel (VX2) if it additionally meets a predetermined storage criterion.

12. The method of claim 1, wherein:
for each second voxel (VX2) whose minimum distance in terms of magnitude lies below a second predetermined threshold value (d2_{MAX}), the distance (d; da2) is stored in the distance attribute, and
for each second voxel (VX2) whose minimum distance in terms of magnitude lies above the second predetermined threshold value (d2_{MAX}), a predetermined distance (d_{±∞}) is stored in the distance attribute.

13. The method of claim 1, wherein the first voxels (VX1) and/or the second voxels (VX2) are each stored in a tree structure, wherein the tree structure comprises a root node and has a predetermined maximum first number of hierarchy levels, and a predetermined second number of sub-nodes can be assigned to each node of a hierarchy level.

14. The method of claim 13, wherein:
the predetermined maximum number of hierarchy levels is three,
the predetermined second number of sub-nodes is 4096 so that 4096 subnodes can be assigned to each node of a hierarchy level, with the exception of the lowest hierarchy level.

15. The method of claim 1, wherein the second voxel model (VM) generated in the first step (S1) has the same number of second voxels (VX2) as the first voxel model (VM) has first voxels (VX1).

16. The method of claim 1, wherein a distance value that is stored in the distance attribute of the respective second voxel (VX2) is adjusted by a predetermined offset distance, and the adjusted distance value (d_{O}) is stored in the distance attribute, wherein for each second voxel (VX2) whose adjusted distance value (d_{O}) lies above the first predetermined threshold value (d_{MAX}), the adjusted distance value (d_{O}) is replaced with the predetermined distance (d_{±∞}).

17. The method of claim 12, wherein a distance value that is stored in the distance attribute of the respective second voxel (VX2) and is not a predetermined distance (d_{±∞}) is adjusted by a predetermined offset distance and the adjusted distance value (d_{O}) is stored in the distance attribute, wherein for each second voxel (VX2) whose adjusted distance value (d_{O}) lies above the first predetermined threshold value (d_{MAX}), the adjusted distance value (d_{O}) by the predetermined distance (d_{±∞}) is replaced.
